(19) United States
(12) Patent Application Publication
(10) Pub. No.: US 2026/0265617 A1
(43) Pub. Date: Sep. 10, 2026

(54) MODIFICATIONS FOR CRACKING HEAVY FEEDSTOCKS

(71) Applicant: Dow Global Technologies LLC, Midland, MI (US)

(72) Inventors: Daniel Beneke, Terneuzen (NL); Georgios Bellos, Terneuzen (NL)

(21) Appl. No.: 19/473,161

(22) PCT Filed: Apr. 20, 2023
(86) PCT No.: PCT/GR2023/000012

§ 371 Date: Oct. 7, 2025

(51) Int. Cl. C10G 9/36; B01J 19/00

(52) U.S. Cl. CPC C10G 9/36; B01J 19/0013; B01J 2219/0009

(57) ABSTRACT

The present disclosure is concerned with a method of cracking heavy feedstocks.

### FIELD OF DISCLOSURE

Embodiments of the present disclosure are directed towards steam cracking of heavy feedstocks and specifically increasing vaporization of heavy feedstocks for cracking.

### BACKGROUND

Steam cracking is a process that can be used in petroleum refining in which heat, sometimes supplemented by high pressure and/or catalysts, is used to break hydrocarbon molecules down into lighter molecules. In steam cracking, a gaseous or liquid hydrocarbon feed such as naphtha, liquefied petroleum gas, or ethane, can be diluted with steam and heated to a cracking temperature in a furnace to break down long chain hydrocarbons into short chain olefins such as ethylene and propylene, among others.

When cracking liquid feedstocks, it is desirable for the feedstock to be adequately vaporized, as unvaporized feedstock can present significant fouling risks when exposed to high temperatures. For example, droplets of feedstock present in the cracking reactor can potentially undergo thermal degradation, leading to fouling formation which necessitates more frequent decoking and cleaning. So, achieving adequate vaporization of the feedstock (e.g., 100% vaporization) is desirable.

Feedstocks that are considered “heavy”, however, can be difficult to vaporize. As a result, the amount of these heavy feedstocks that can be fed to the steam cracking reactor is limited. Blending a stream of lighter hydrocarbons with a heavy feedstock can enhance the vaporization by reducing the partial pressure of the heavy feedstock. However, common design conditions can only ensure complete vaporization of feedstocks containing a small percentage of heavy feedstock. As a result, there is a limit on the amount of heavy hydrocarbon that can be processed and so there is a need in the art to address this problem.

### SUMMARY

The present disclosure provides for processes for preparing a feed for cracking. Specifically, in one aspect, the present disclosure provides for a process for preparing a feed for cracking that includes heating a stream of boiler feed water to produce a stream of high-pressure steam using heat from a cracking furnace; preheating a stream of dilution steam having a first enthalpy in a dilution steam preheater using a fraction of the stream of high-pressure steam to produce a stream of a preheated dilution steam having a second enthalpy larger than the first enthalpy; heating the stream of the preheated dilution steam having the second enthalpy in a dilution steam super-heater to produce a superheated dilution steam having a third enthalpy larger than the second enthalpy; and mixing the superheated dilution steam with the feed to prepare the feed for cracking. Some embodiments include fully vaporizing a mixture of the superheated dilution steam and the feed using heat from the cracking furnace prior to cracking. Some embodiments include controlling the fraction of the stream of high-pressure steam used to preheat the stream of dilution steam to ensure the third enthalpy is sufficient for fully vaporizing the mixture of the superheated dilution steam and the feed using heat from the cracking furnace. In some embodiments the feed includes a heavy feedstock of C4 to C35 hydrocarbons. In some embodiments preheating the stream of dilution steam using the fraction of the stream of high-pressure steam includes condensing the fraction of the stream of high-pressure steam; and further include conditioning the condensed high-pressure steam in a boiler feed water recovery system; and mixing the conditioned condensed high-pressure steam with the stream of boiler feed water to be heated. Some embodiments include retrofitting the dilution steam preheater to a preexisting cracking furnace.

### BRIEF DESCRIPTION OF DRAWINGS

FIG. 1 is a schematic diagram of a typical cracking furnace in a steam cracking plant for ethylene production.

FIG. 2 is a distillation curve for naphtha.

FIG. 3 is a graph of inlet process temperature-dew point differences for a mixture of naphtha and n-pentadecane.

FIG. 4 is a schematic view of a cracking furnace system that includes a dilution steam preheater.

FIG. 5 is a graph of inlet process temperature-dew point differences for a mixture of naphtha and n-pentadecane with dilution steam preheating.

### DETAILED DESCRIPTION

The present disclosure provides for a process for preparing a feed for cracking that can increase the amount of heavy hydrocarbon a cracking furnace can process. More specifically, the present disclosure relates to preparing a feed containing a heavy feedstock for cracking by producing a stream of a preheated dilution steam to mix with the feed. In this way, the present disclosure helps to better ensure that a feed containing heavy hydrocarbons is fully vaporized for cracking, as unvaporized hydrocarbons present in some tube bundles, particularly where flue gas temperatures are high, can present significant fouling risks. For example, if liquid is present, droplets may deposit on inner tube walls and undergo thermal degradation which can lead to coke formation. The present disclosure also provides for a dilution steam preheater that may be externally attached to a cracking furnace. In this way, the present disclosure helps allow the modification of existing cracking furnaces for cracking heavy feedstocks.

As used herein, high-pressure steam refers to steam having a pressure of 1600 PSI to 1800 PSI and a temperature of 320° C. to 550° C.

As used herein, recited values can be proceeded by the word approximately. For example, high-pressure steam refers to steam having a pressure of approximately 1600 PSI to approximately 1800 PSI and a temperature of approximately 320° C. to approximately 550° C.

As used herein, saturated steam refers to water that has been vaporized, where both liquid and gas phases can be present at a given temperature and pressure.

As used herein reactor section refers to the portion of a cracking furnace where steam cracking takes place. As used herein, steam cracking refers to a process in which heat is used to break hydrocarbon molecules down into lighter molecules.

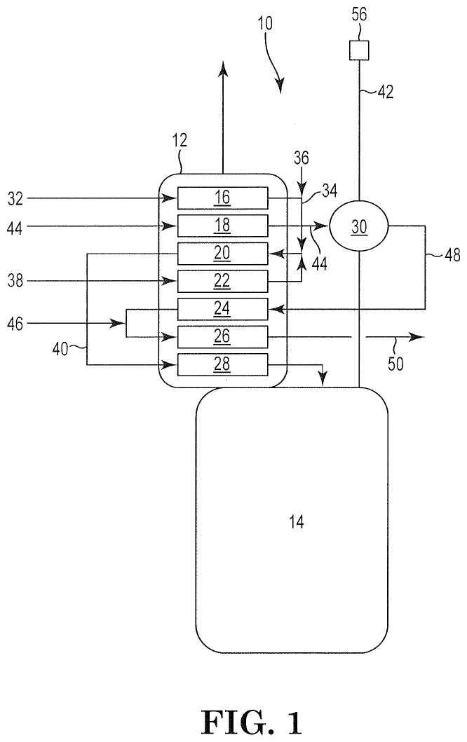

From a sustainability perspective, steam cracking of heavy liquid feeds such as hydro processed bio-based oil (e.g., hydrotreated vegetable oil), syngas liquid products, and hydrotreated waste plastic pyrolysis oil can help reduce the need for fossil-based feedstocks and help to decarbonize cracking furnaces. As heavier feedstocks can require more energy to vaporize, one approach for cracking heavy liquid feedstocks is to purpose-build a cracking furnace with modifications such as a modified feed heater, a flash drum to collect any unvaporized feed, or other modifications. The amount of heavier feedstock that can be fully vaporized can be limited in a cracking furnace that is not purpose-built for heavy liquid feedstocks, however, a purpose built furnace can be expensive to implement. Another approach can be to mix a heavy hydrocarbon feedstock with a stream of lighter hydrocarbons. In this approach, the stream of lighter hydrocarbons helps to reduce the partial pressure of the heavy feedstock. This technique can allow cracking of heavy feedstocks in cracking furnaces that are not purpose-built for cracking heavy feedstocks. An example of such a furnace that is not purpose-built for cracking heavy feedstocks can be seen in FIG. 1.

FIG. 1 shows a schematic diagram of a typical cracking furnace 10 in a steam cracking plant for ethylene production. The cracking furnace 10 in FIG. 1 is a generic example of a furnace. Alternative arrangements are possible. The cracking furnace 10 shown in FIG. 1 includes a convection section 12 containing a number of heat exchangers heated by flue gas from a reactor (or radiant) section 14. The convection section 12 can have a variety of layouts for each furnace design as would be known to one skilled in the art. In FIG. 1 the heat exchangers depicted in the convection section 12 can include a feed preheating exchanger (FPH) 16, an economizer bundle 18, a first high temperature coil (HTC-1) 20, a dilution steam super-heater (DSSH) 22, a first high-pressure superheater bundle (HPSSH1) 24, a second high-pressure superheater bundle (HPSSH2) 26, and a second high temperature coil (HTC-2) 28. The cracking furnace may also include a transfer line exchanger (TLE) 30. In the cracking furnace 10 arrangement depicted by FIG. 1 a liquid feed 32 is preheated and partially vaporized by the FPH 16 where flue gas temperatures are low. The preheated and partially vaporized feed 34 is mixed with a small liquid petroleum gas (LPG) stream 36 in this cracking furnace 10 arrangement. Once the feed has been preheated, dilution steam 38 is preheated in the DSSH 22. These two streams can be mixed and fed into the downstream high temperature coil exchangers HTC-I 20 and HTC-II 28 to form a fully vaporized feed mixed with dilution steam (FVF) 40. The FVF 40 enters the reactor section 14 where long chain hydrocarbons in the vaporized feed are broken down into short chain olefins like ethylene and propylene, among others. Exiting the radiant section 14, a hot effluent 42 is rapidly cooled in the TLE 30 against preheated boiler feed water 44 (Boiler feed water (BFW) 44 that has been preheated in the economizer bundle 18) to prevent secondary undesirable reactions. The preheated BFW 44 is vaporized in the TLE 30 to form saturated steam 48. The saturated steam 48 produced in the TLE 30 can, for example, have a temperature around 320° C. The saturated steam 48 is further heated in in high-pressure superheater (HPSSH) bundles HPSSH1 24 and HPSSH2 26 in the convection section 12, to temperatures that can range from 450° C. to 550° C., to form a high-pressure steam (HPS) 50. Boiler feed water 46 can also be injected between the HPSSH1 24 and HPSSH2 26 bundles to control the temperature of the final HPS 50 from HPSSH2 26. HPS 50 produced in the furnace can be utilized for driving downstream compressor turbines 56, can be let down to lower steam pressure levels for other consumers, or can be used for other purposes. The HPS 50 produced by a cracking furnace can be more than the downstream HPS requirements. Electrified compressor turbines can cause an even greater excess of HPS. After downstream uses, HPS can be condensed and routed back to the suction of boiler feed water pumps or directly to a TLE system.

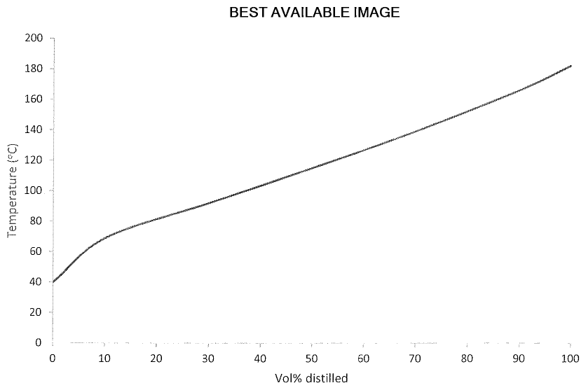

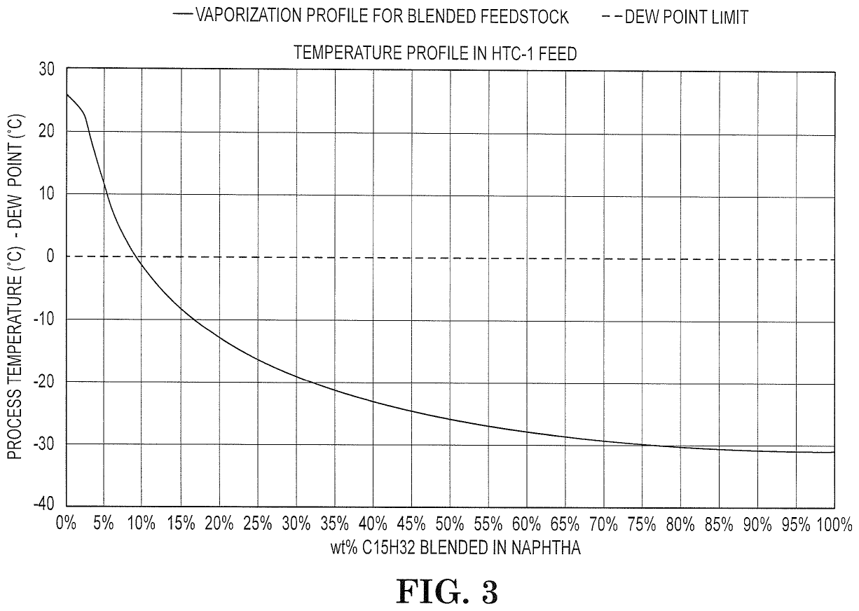

A particular problem with cracking heavy feedstocks through this technique of mixing a stream of lighter hydrocarbons with a heavy feed, however, is that common design conditions of cracking furnaces can only ensure complete vaporization a feed containing a small percentage of heavy feedstock. To illustrate this, a simulation was performed, using Aspen Plus version 11, for the cracking furnace 10 of FIG. 1, operating at the conditions presented by Karimzadeh et al. and summarized in Append A. The heavy feed used was n-pentadecane (C15H32) mixed with Naphtha with a distillation curve as shown in FIG. 2. The results are seen in FIG. 3.

FIG. 3 is a graph of inlet process temperature-dew point differences for a mixture of naphtha and n-pentadecane at the HTC-1 20 bundle's inlet. FIG. 3 shows that under standard design conditions (0% n-Pentadecane cofeeding), around 26° C. of superheat above the feedstock's dewpoint is achieved. However, when cofeeding with n-Pentadecane, only 9 weight percent (Wt. %, based on the total weight of the feed) n-pentadecane can be blended while ensuring full vaporization in the HTC-1 20 feed line.

Higher proportions of a heavier feedstock can be introduced into existing furnaces, without modifying the existing furnace layout, by externally adding enthalpy to the feed. Preheating a hydrocarbon feedstock directly to ensure complete vaporization may lead to fouling when dilution steam has not been added and the partial pressure of fouling prone components are high.

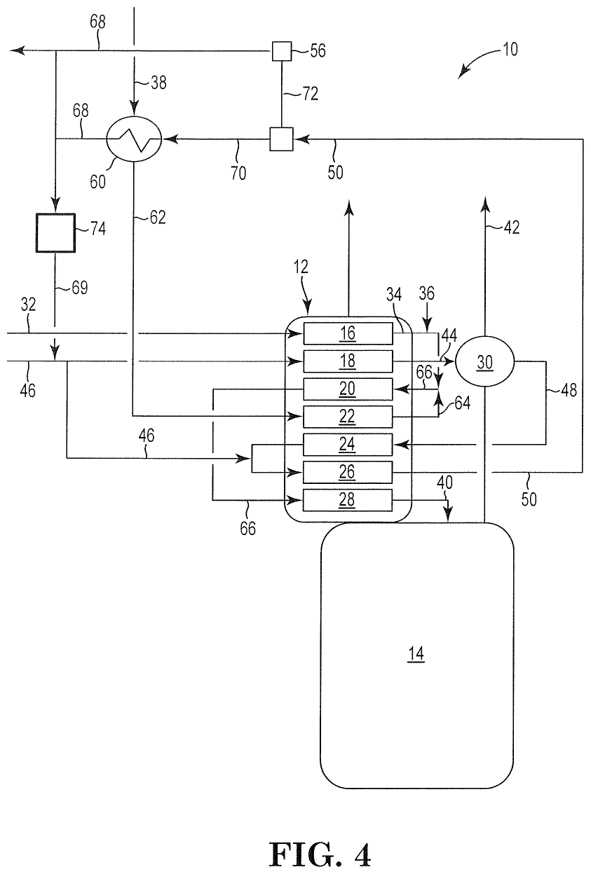

Given the above information, the present disclosure provides for a method of, among other things, producing a stream of preheated dilution steam to mix with a feed containing a heavy feedstock to help better ensure that the feed is fully vaporized before cracking. More specifically, the present disclosure provides for a process for preparing a feed for cracking that includes heating a stream of boiler feed water 46 to produce a stream of high-pressure steam 50 using heat from a cracking furnace 10; preheating a stream of dilution steam 38 having a first enthalpy in a dilution steam preheater (e.g., dilution steam preheater 60 in the embodiment shown in FIG. 4) using a fraction of the stream of high-pressure steam (e.g., fraction of the stream of high-pressure steam 70 in the embodiment shown in FIG. 4) to produce a stream of a preheated dilution steam (e.g., stream of preheated dilution steam 62 in the embodiment shown in FIG. 4) having a second enthalpy larger than the first enthalpy; heating the stream of the preheated dilution steam 62 having the second enthalpy in a dilution steam super-heater 22 to produce a superheated dilution steam (e.g., superheated dilution steam 64 in the embodiment shown in FIG. 4) having a third enthalpy larger than the second enthalpy; and mixing the superheated dilution steam 64 with the feed 32 to prepare the feed 32 for cracking. Producing the preheated dilution steam 62 helps to increase the enthalpy added to the feed so that the third enthalpy is sufficient for a mixture of the superheated dilution steam and the feed (e.g., mixture of superheated dilution steam and the feed 66 in the embodiment shown in FIG. 4) to have a temperature that exceeds a dewpoint of the mixture. This helps to ensure feeds with increased wt. % of heavy feedstock are fully vaporized with low, or no, additional fouling risk, such as may be caused by direct heating of hydrocarbon feedstocks or using cracked gas exiting the reactor section to heat dilution steam. In this way, the present disclosure can help allow the cracking of a variety of heavy feedstocks, including natural gas condensates, shale oil, shale gas heavy condensates, and feedstocks that can increase sustainability, such as hydro processed bio-based oils typically represented by C12-C20 paraffins, fossil-based naphtha containing C4-C11 hydrocarbons, effluents from the pyrolysis of plastics containing hydrocarbons up to C30-C35, jet fuel, kerosene, diesel, fossil-based gas condensates, and other hydrocarbon feeds in the C4 to C35 range.

The methods of the present disclosure can be performed in, or attached to, a cracking furnace which can have any number of different configurations as are known in the art. In some embodiments the stream of preheated dilution steam can be produced outside of a cracking furnace used in cracking the feed. For example, the preheated dilution steam can be produced by a dilution stream preheater that can be placed externally to the cracking furnace in an area without space constraints. The cracking furnace area, which can be congested, can be completely avoided and the dilution steam preheater can be constructed and maintained in an accessible location. This can allow an existing cracking furnace not designed for heavy feedstocks to be adapted to accept heavier feedstocks with relatively small modification and can help reduce extensive renovations of the cracking furnace itself. While a dilution steam preheater can be constructed externally to a cracking furnace, other designs can include a dilution steam preheater within a cracking furnace, however, the end result of preheating a dilution steam to increase vaporization of heavy feedstocks is the same.

In addition, preheating dilution steam can help to obtain a full cracking value of a blended stream without necessitating a yield loss of a heavy tail such as may be caused by using a flash drum to separate unvaporized feedstock.

In some embodiments the feed 32 includes 0.1 to 100 wt. % of a heavy feedstock of C4 to C35 hydrocarbons.

In some embodiments producing the stream of the preheated dilution steam 62 includes supplying a dilution steam 38 to the dilution steam preheater 60 that produces the stream of the preheated dilution steam 62 having the second enthalpy. The dilution steam 38 can be preheated by the dilution steam preheater 60 in various ways. In some embodiments the dilution steam preheater 60 can use an electrical heater to produce the stream of the preheated dilution steam 62 having the second enthalpy.

In some embodiments the dilution steam preheater 60 uses a high-pressure steam to produce the stream of the preheated dilution steam having the second enthalpy by heating the dilution steam 38 having the first enthalpy to produce a preheated dilution steam 62 that can have a temperature of 300° C. to 500° C. It may also be possible to reduce the temperature of a high-pressure steam to 300° C. to 500° C. to be used as the preheated dilution steam. The temperature of the preheated dilution steam may be determined by the requirements to fully vaporize the feed for a specific furnace and feedstock. For a modified cracking furnace, the temperature of the preheated dilution steam may be controlled to help keep the temperature and pressure of the dilution steam within the operating window of the modified cracking furnace, and to help maintain the original capability of the modified cracking furnace with regards to cracking yields, dilution steam ratio, fouling risks, and energy consumption. The temperature of the preheated dilution steam may also be controlled to ensure adequate heating potential to fully vaporize previously unvaporized heavy feedstocks.

Some embodiments can include producing a high-pressure steam 50 from heat generated in a cracking furnace 10 used for cracking the feed. This high-pressure steam 50 is typically used to drive downstream compressor turbines before being converted into boiler-feed water. This high-pressure steam can be the high-pressured steam used by the dilution steam preheater to produce the preheated dilution steam. In some embodiments the cracking furnace may produce more high-pressure steam than required to produce the preheated dilution steam, so some embodiments may include diverting a first side stream of high-pressure steam from the stream of high-pressure steam to be used for preheating the dilution steam. This first side stream of high-pressure steam may be put to a variety of uses including producing electrical energy, such as by using a turbine. In embodiments where high-pressure steam is diverted from electricity production to be used to produce preheated dilution steam, it may be possible to recover energy from the diverted high-pressure steam, such as by incorporating electrical drives after the diverted high-pressure steam has been used to heat the dilution steam.

FIG. 4 is a schematic view of a cracking furnace system 52 that includes a dilution steam preheater 60 as provided for by the present disclosure. More specifically this disclosure provides for a cracking furnace system 52 that can include a cracking furnace 10, having a reactor section 14 and a convection section 12 attached to the reactor section 14. The convection section 12 including a dilution steam super-heater 22, a high-pressure steam generator to produce a stream of high-pressure steam 50, and a high temperature coil (e.g. HTC-1 20, and HTC-2 28). The cracking furnace system 52 can also include a dilution steam preheater 60 coupled to the dilution steam super heater 22. A fraction of the stream of high-pressure steam 70 produced by the high-pressure steam generator being used by the dilution steam preheater 60 to heat a stream of dilution steam having a first enthalpy to produce a preheated dilution steam having 62 a second enthalpy, the dilution steam super heater 22 heating the preheated dilution steam 62 to produce a superheated dilution steam 64 having a third enthalpy larger than the second enthalpy, the high temperature coil (e.g. HTC-1 20, HTC-2 28) mixing and heating a feed 32 and the superheated dilution steam 64 to produce a fully vaporized feed mixed with dilution steam 40. The reactor section 14 cracking the fully vaporized feed mixed with dilution steam 40.

The feed 32 and the superheated dilution steam 64 in this example are first mixed to produce a mixture of the superheated dilution steam and the feed 66 before being heated to produce the fully vaporized feed mixed with dilution steam 40.

The high-pressure steam generator in this example includes the economizer bundle 18, transfer line exchanger 30, first high-pressure superheater bundle 24, and second high-pressure superheater bundle 26. Alternative configurations for high-pressure steam generation are also possible.

The stream of high-pressure steam (HPS) 50 can be produced through any of a variety of other means, as would be known by one of ordinary skill in the art. In some embodiments, the HPS 50 used by the dilution steam preheater 60 is produced by the high-pressure steam generator. The high-pressure steam generator can have a variety of configurations as would be known to one skilled in the art, however the end result of producing HPS 50 is the same.

In some embodiments, the dilution steam preheater 60 can utilize one or more separate heat exchangers to produce the preheated dilution steam 62. For example, a first heat exchanger can be used to de-superheat the fraction of the HPS 70 to its dew point and a second heat exchanger can be used to condense the de-superheated HPS. In some embodiments the condensed high-pressure steam 68 can be conditioned in a boiler feed water recovery system 74, and the conditioned condensed high-pressure steam 69 can be mixed with the stream of boiler feed water 46 to be heated.

In some embodiments the dilution steam preheater 60 can be externally attached to the cracking furnace 10. This may help to allow modification of an existing furnace.

In some embodiments, it is desirable to fully vaporize a feedstock, as such, more energy that is required to fully vaporize a feedstock can be added to the preheated steam. However, it is also noted that a dilution steam preheater 60 can be used to “substantially” fully vaporize a feed for cracking and used in conjunction with other methods to remove any unvaporized feedstock. Some embodiments can include fully vaporizing the mixture of superheated dilution steam and the feed 66 using heat from the cracking furnace 10 prior to cracking.

Some embodiments include acquiring the fraction of the stream of high-pressure steam 70 from a remaining stream of high-pressure steam 72. some embodiments can include controlling the fraction of the stream of high-pressure steam 70 used to preheat the stream of dilution steam 38 to ensure the third enthalpy is sufficient for fully vaporizing the mixture of superheated dilution steam and the feed 66 using heat from the cracking furnace 10.

In some embodiments, preheating the stream of dilution steam 38 using the fraction of the stream of high-pressure steam 70 includes condensing the fraction of the stream of high-pressure steam. Some embodiments include conditioning the condensed high-pressure steam 68 in a boiler feed water recovery system 74, and mixing the conditioned condensed high-pressure steam 69 with the stream of boiler feed water 46 to be heated.

Some embodiments include producing electricity using the remaining stream of high-pressure steam, condensing the remaining high-pressure steam, conditioning the condensed high-pressure steam 68 in a boiler feed water recovery system 74, and mixing the conditioned condensed high-pressure steam 69 with the stream of boiler feed water 46 to be heated. Some embodiments include using electrical drives 56 for producing the electricity with the remaining stream of high-pressure steam 72.

Some embodiments can include retrofitting the dilution steam preheater 60 to a preexisting cracking furnace 10.

### Example

The below example is provided to be illustrative only and is not intended to define or limit the embodiments in any way.

### Dilution Steam Preheating Simulation

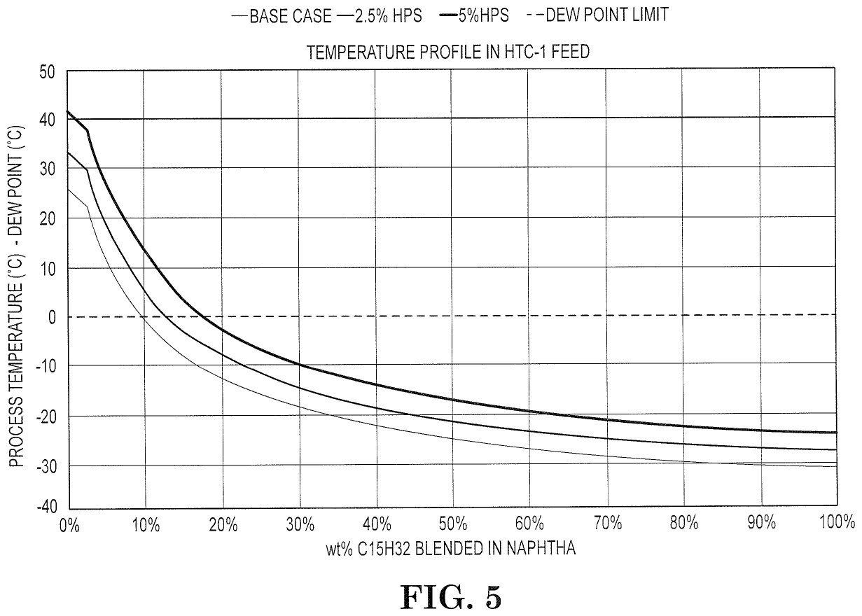

FIG. 5 presents temperature profiles for the cracking furnace 10 configuration presented in FIG. 1 modified by a dilution steam preheater 60 as presented in FIG. 4 and operating with the feedstock properties presented by Table 1. The curves in FIG. 5 represents a case where the dilution steam preheater 60 uses 0%, 2.5%, and 5% of the total high-pressure steam produced by the high-pressure steam generator.

### Results

The curves generated by the simulation assume full condensation of the HPS in the dilution steam preheater. FIG. 5 shows that using 2.5% of the total high-pressure steam 50 produced, allows the blending of the heavy feedstock (pentadecane) into naphtha to be increased to 12% compared to the furnace operating without dilution steam preheating. FIG. 5 shows that using 5% of the total high-pressure steam 50 produced, allows the blending of the heavy feedstock (pentadecane) into naphtha to be increased to 18% compared to the furnace operating without dilution steam preheating where only 9% heavy feedstock could be blended to still ensure adequate vaporization in the HTC-1 20 bundle.

1. A process for preparing a feed for cracking, comprising:
heating a stream of boiler feed water to produce a stream of high-pressure steam using heat from a cracking furnace;
preheating a stream of dilution steam having a first enthalpy in a dilution steam preheater using a fraction of the stream of high-pressure steam to produce a stream of a preheated dilution steam having a second enthalpy larger than the first enthalpy;
heating the stream of the preheated dilution steam having the second enthalpy in a dilution steam super-heater to produce a superheated dilution steam having a third enthalpy larger than the second enthalpy; and
mixing the superheated dilution steam with the feed to prepare the feed for cracking.

2. The process of claim 1, further including fully vaporizing a mixture of the superheated dilution steam and the feed using heat from the cracking furnace prior to cracking.

3. The process of claim 2, further including controlling the faction of the stream of high-pressure steam used to preheat the stream of dilution steam to ensure the third enthalpy is sufficient for fully vaporizing the mixture of the superheated dilution steam and the feed using heat from the cracking furnace.

4. The process of claim 1, wherein the feed includes a heavy feedstock of C4 to C35 hydrocarbons.

5. The process of claim 1, wherein;
preheating the stream of dilution steam using the fraction of the stream of high-pressure steam includes condensing the fraction of the stream of high-pressure steam; and
further including conditioning the condensed high-pressure steam in a boiler feed water recovery system; and
mixing the conditioned condensed high-pressure steam with the stream of boiler feed water to be heated.

6. The process of claim 1, further including retrofitting the dilution steam preheater to a preexisting cracking furnace.

7. The process of claim 1, further including acquiring the fraction of the stream of high-pressure steam from a remaining stream of high-pressure steam.

8. The process of claim 7, further including producing electricity using the remaining stream of high-pressure steam;
condensing the remaining stream of high-pressure steam;
conditioning the condensed high-pressure steam in a boiler feed water recovery system; and
mixing the conditioned condensed high-pressure steam with the stream of boiler feed water to be heated.

9. The process of claim 8, further including using electrical drives for producing the electricity with the remaining stream of high-pressure steam.

10. A cracking furnace system, comprising:
a cracking furnace, having:
a reactor section; and
a convection section attached to the reactor section, wherein the convection section includes a dilution steam super-heater, a high-pressure steam generator to produce a stream of high-pressure steam, and a high temperature coil; and
a dilution steam preheater coupled to the dilution steam super heater, wherein a fraction of the stream of high-pressure steam produced by the high-pressure steam generator is used by the dilution steam preheater to heat a stream of dilution steam having a first enthalpy to produce a preheated dilution steam having a second enthalpy larger than the first enthalpy, the dilution steam super heater heats the preheated dilution steam to produce a superheated dilution steam having a third enthalpy larger than the second enthalpy, the high temperature coil mixes and heats a feed and the superheated dilution steam to produce a fully vaporized feed mixed with dilution steam, and wherein the reactor section cracks the fully vaporized feed mixed with dilution steam.

11. The system of claim 10, wherein the dilution steam preheater is externally attached to the cracking furnace.

12. The system of claim 10, wherein the preheated dilution steam has a temperature of 300° C. to 500° C.
